(19) United States
(12) Patent Application Publication
(10) Pub. No.: US 2011/0295678 A1
(43) Pub. Date: Dec. 1, 2011

(54) Expanding Ad Group Themes Using Aggregated Sequential Search Queries

(75) Inventors: Jasper Seldin, San Francisco, CA (US); Jonathan Yahalom, Oak Park, CA (US); Lindsey Wall, Stockton, CA (US); Shilpa Jain, Glendale, CA (US); Charlie Vestner, Burlingame, CA (US); Rebecca Illowsky, Menlo Park, CA (US)

(73) Assignee: GOOGLE INC., Mountain View, CA (US)

(21) Appl. No.: 12/790,737

(22) Filed: May 28, 2010

(51) Int. Cl. G06Q 30/00; G06Q 10/00; G06F 17/30

(52) U.S. Cl. 705/14.42; 705/14.54; 707/769; 707/E17.014

(57) ABSTRACT

Methods, systems, and apparatus, including computer programs encoded on a computer storage medium, for creating ad groups based on sequential search queries are disclosed. A seed ad group theme can be selected. Aggregated sequential search queries can be obtained from a seed search query having identical terms as the seed ad group theme. The aggregated sequential search queries can be used as additional ad group themes for generating new ad groups. Keywords can be selected for each new ad groups based on one or more performance criteria. Performance of ad groups and keywords and changes in aggregated sequential search queries can be monitored for subsequent ad group creation, removal, and dynamic tuning.

### BACKGROUND

This specification relates to online advertising.

The Internet provides access to a wide variety of resources, such as text, images, videos, audio files, and other multimedia content. Such access has enabled opportunities for targeted online advertising. Ad slots can be defined on webpages, and advertisements can be statically or dynamically inserted into the ad slots when the webpages are retrieved and rendered in a user's browser. The selection of advertisements can target keywords or topics of the published content on the webpages.

An advertising management system can be used to facilitate the value exchange between advertisers and publishers (e.g., web content publishers). Advertisers provide advertisements, specify targeting criteria for ad campaigns, and offer bids for the opportunities to have their advertisements presented on publishers' webpages. Online advertisers use advertising management tools to manage their advertising campaigns. These management tools include an account interface that allows an advertiser to create and define various aspects of advertising campaigns and ad groups, such as keywords, targeting criteria, budgets, bids for ad placement, duration, different types of advertisements, and so on. After the advertiser has specified the campaign and ad group data and activated the advertising campaigns and/or ad groups, advertisements can be dynamically selected and served on publishers' webpages according to the various keywords and other targeting criteria specified by the advertiser.

### SUMMARY

This specification describes technologies relating to management of online advertising campaigns.

In general, one innovative aspect of the subject matter described in this specification can be embodied in methods that include the actions of: obtaining a first seed ad group theme, the first seed ad group theme consists of one or more terms; obtaining first aggregated sequential search queries of a first seed search query, the first seed search query consisting of the one or more terms of the first seed ad group theme, and each of the first aggregated sequential search queries being a respective search query that has been submitted in sequence with the first seed search query to a search system by more than a threshold number of users during a respective search session associated with each user; selecting one or more of the first aggregated sequential search queries as suggested ad group themes; and creating one or more new ad groups for advertising in a content network, each new ad group corresponding to a respective one of the suggested ad group themes.

In some implementations, the action of obtaining the first seed ad group theme further includes the action of: receiving, from a user and through an interface of a campaign management environment, the one or more terms of the first seed ad group theme.

In some implementations, the methods further include the actions of: presenting a hierarchy comprising a root node and a plurality of child nodes below the root node, the root node corresponding to the first seed search query, and each child node corresponding to a respective one of the first aggregated sequential search queries of the first seed search query; receiving first user input expanding one of the plurality of child nodes, the expanded child node corresponding to a respective aggregated sequential search query; and in response to the received first user input, presenting additional child nodes descending from the expanded child node, each additional child node corresponding to a respective second aggregated sequential search query of the respective aggregated sequential search query corresponding to the expanded child node.

In some implementations, the action of selecting one or more of the aggregated sequential search queries as suggested ad group themes further includes the actions of: receiving second user input selecting one or more of the plurality of child nodes in the hierarchy; and using the aggregated sequential search queries corresponding to the selected child nodes as the suggested ad group themes.

In some implementations, the action of obtaining the first seed ad group theme further includes the actions of: determining respective performances of one or more existing ad groups in an advertising account based on one or more criteria; selecting one of the existing ad groups as a seed ad group based on a better performance of the selected existing ad group among the existing ad groups; and using a theme of the selected existing ad group as the first seed ad group theme.

In some implementations, the action of obtaining the first seed ad group theme further includes the actions of: monitoring respective performances of one or more existing ad groups in an advertising campaign; selecting one of the existing ad groups as a seed ad group if the performance of the existing ad group exceeds a predetermined threshold; and using a theme of the selected existing ad group as the first seed ad group theme.

In some implementations, the action of obtaining the first aggregated sequential search queries of the first seed search query further includes the action of: periodically, obtaining an update on the first aggregated sequential search queries of the first seed search query, wherein the update indicate aggregated sequential search queries have been submitted to the search system within a most recent time period of a predetermined duration.

In some implementations, the action of creating one or more new ad groups for advertising in the content network further includes the actions of: for each of the one or more new ad groups, obtaining a plurality of suggested keywords for the new ad group, the plurality of suggested keywords being based on the respective terms of the suggested ad group theme; and creating the new ad group using a subset of the plurality of suggested keywords.

In some implementations, the action of creating the new ad group using the subset of the plurality of suggested keywords further includes the actions of: presenting the plurality of suggested keywords in an order according to a predetermined criterion; receiving user input selecting the subset of suggested keywords from the plurality of suggested keywords; and creating the new ad group using the user-selected subset of suggested keywords.

In some implementations, the action of creating the new ad group using the subset of the plurality of suggested keywords further includes the actions of: selecting the subset of suggested keywords based on a predetermined threshold search volume; and creating the new ad group using the subset of suggested keywords selected based on the predetermined threshold search volume.

In some implementations, the methods further include the actions of: selecting at least one of the first aggregated sequential search queries of the first seed search query as a second seed search query; obtaining second aggregated sequential search queries of the second seed search query; selecting one or more of the second aggregated sequential search queries as additional suggested ad group themes; and creating additional new ad groups for advertising in the content network, each additional new ad group corresponding to a respective one of the additional suggested ad group themes.

Other embodiments of this aspect include corresponding systems, apparatus, and computer programs, configured to perform the actions of the methods, encoded on computer storage devices.

In general, another innovative aspect of the subject matter described in this specification can be embodied in methods that include the actions of: receiving a seed ad group theme from a user, the seed ad group theme consists of one or more terms; presenting aggregated sequential search queries of a seed search query to the user, the seed search query consisting of the one or more terms of the seed ad group theme, and each of the aggregated sequential search queries being a respective search query that has been submitted in sequence with the seed search query to a search system by more than a threshold number of search engine users during a respective search session associated with each search engine user; receiving first user input selecting one or more of the aggregated sequential search queries as new ad group themes; presenting a respective plurality of suggested keywords for each new ad group theme; receiving second user input selecting a subset of the respective plurality of suggested keywords as keywords for each new ad group theme; and creating one or more new ad groups for advertising in a content network, each new ad group corresponding to a respective one of the new ad group themes and including the subset of suggested keywords selected for the new ad group theme.

Other embodiments of this aspect include corresponding systems, apparatus, and computer programs, configured to perform the actions of the methods, encoded on computer storage devices.

In general, another innovative aspect of the subject matter described in this specification can be embodied in methods that include the actions of: monitoring performance of one or more existing ad groups based on one or more predetermined performance measures; selecting one of the existing ad groups as a seed ad group based on the ad group's performance, the selected seed ad group having an ad group theme consisting of one or more terms; obtaining aggregated sequential search queries of a seed search query, the seed search query consisting of the one or more terms of the seed ad group theme, and each of the aggregated sequential search queries being a respective search query that has been submitted in sequence with the seed search query to a search system by more than a threshold number of search engine users during a respective search session associated with each search engine user; selecting one or more of the aggregated sequential search queries as new ad group themes; obtaining suggested keywords for each new ad group theme; selecting one or more of the suggested keywords for each new ad group theme as keywords for inclusions in a respective new ad group corresponding to the new ad group theme; and creating one or more new ad groups for advertising in a content network, each new ad group corresponding to a respective one of the new ad group themes and including the selected keywords for the new ad group theme.

Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. Aggregated sequential search data identify pairs of search queries that have been submitted in sequence to a search engine by a large number of users in a respective search session associated with each user. The aggregated sequential search data captures the collective recognition of the relatedness between particular concepts, words, and phrases by many people. Aggregated sequential search queries of a seed search query can be used to generate additional ad group themes related to a seed ad group theme, where each ad group theme is specified by the search terms of a respective search query.

From a seed search query, a group of aggregated sequential search queries can be obtained. Each of the aggregated sequential search queries can be used as a new seed search query to obtain additional aggregated sequential search queries of the new seed search query. Owing to the abundance of aggregated sequential search queries that can be obtained for each initial seed query (e.g., either directly from the initial seed search query or via one or more intermediate aggregated sequential search queries), a large number of ad groups themes can be generated from each seed ad group theme. Ad group theme generation no longer has to be limited by the knowledge and experience of an individual person, but can rely on the collective knowledge and experience of many people. With an increased number of ad groups in operation, the chance of finding a successful ad group can also be increased.

In addition, a wide array of publisher content can be covered by the large number of ad groups generated using the aggregated sequential search query data. Broad content coverage no longer has to rely on a large number of keywords used in each of a small number of ad groups. Instead, a few very specific targeting keywords can be established for each of a large number of specific ad groups, such that content matching to the targeting keywords can be more effective and successful. As a result, the overall number of successful matching between ads and publisher content can be increased.

Furthermore, new ad group generation can be based on a small number of existing ad groups that have performed well in the past. The additional ad groups generated based on these successful seed ad groups can help maximize the success in particular subsectors of the market. The identification of successful ad groups and generation of new ad groups based on newly emerged successful ad groups can be automated and performed periodically or upon detection of a successful ad group. In addition, keyword selection and update for each ad group can also be automated and based on various evolving success factors, such as search volume. As a result, the overall performance of all ad groups in operation as well as individual performance of each ad group can be continuously optimized over time.

Moreover, the ad groups in operation can be dynamically adjusted based on the current consumer trend reflected in the evolving aggregated sequential search data. When new concepts and new relationships between concepts emerge among consumers, such emergence can be captured in the aggregated sequential search queries and used as a trigger for creating new ad group themes. Similarly, declining trend and dissolving relationships between two concepts can be captured by the decline of sequential searches performed for the two concepts. Particular ad groups can be removed if the aggregated sequential search data suggests that the ad groups' themes are no longer related to the theme of a successful seed ad group from which the particular ad groups were generated.

The ad groups in operation can be dynamically tuned based on ad group performance. Older and poorer performing ad groups can be switched out by new ad groups. Keywords having declining search volume can be replaced with keywords having rising search volume. Thus, a set of high performance ad groups can be maintained over an extended period of time.

The above and other features of the method and systems described in the instant specification can benefit the consumers, the advertisers, the publishers, and the advertising service providers. In particular, small advertisers have conventionally relied on a small number of generic ad groups having large numbers of keywords for targeting. These small advertisers often fail to establish successful ad groups to reach their daily advertising budget due to unsuccessful content matching. The methods and systems disclosed in the present specification can help these small advertisers to easily and conveniently establish a large online presence by having a large number of highly specific ad groups each having a small number of keywords. The large number of specific ad groups as a whole covers a large array of online content, and individually has improved success in content matching. Therefore, the value exchange between advertisers and the content publishers can be improved.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example online advertising environment.

FIG. 2A is an example advertiser management server that generates ad groups based on aggregated sequential search queries.

FIG. 2B is an example user interface for presenting suggested ad group themes and suggested keywords for a suggested ad group theme.

FIG. 3 is a flow diagram of an example process for generating ad groups based on aggregated sequential search queries.

FIGS. 4A-4B are flow diagrams of example processes for dynamically tuning the collection of ad groups in operation based on the seed ad group selection.

FIG. 5 is a flow diagram of an example process for presenting a user interface for exploring aggregated sequential search queries from a seed search query.

FIG. 6 is a flow diagram of an example process for generating additional ad group themes using aggregated sequential search queries that are indirectly associated with the seed search query.

FIG. 7 is a flow diagram of an example process for selecting keywords for the new ad groups.

FIG. 8 is a flow diagram of an example process that facilitates user participation of the ad group creation based on aggregated sequential search queries.

FIG. 9 is a flow diagram of an example process for automatic ad group creation based on aggregated sequential search queries.

Like reference numbers and designations in the various drawings indicate like elements.

### DETAILED DESCRIPTION

### I. Online Advertising Environment

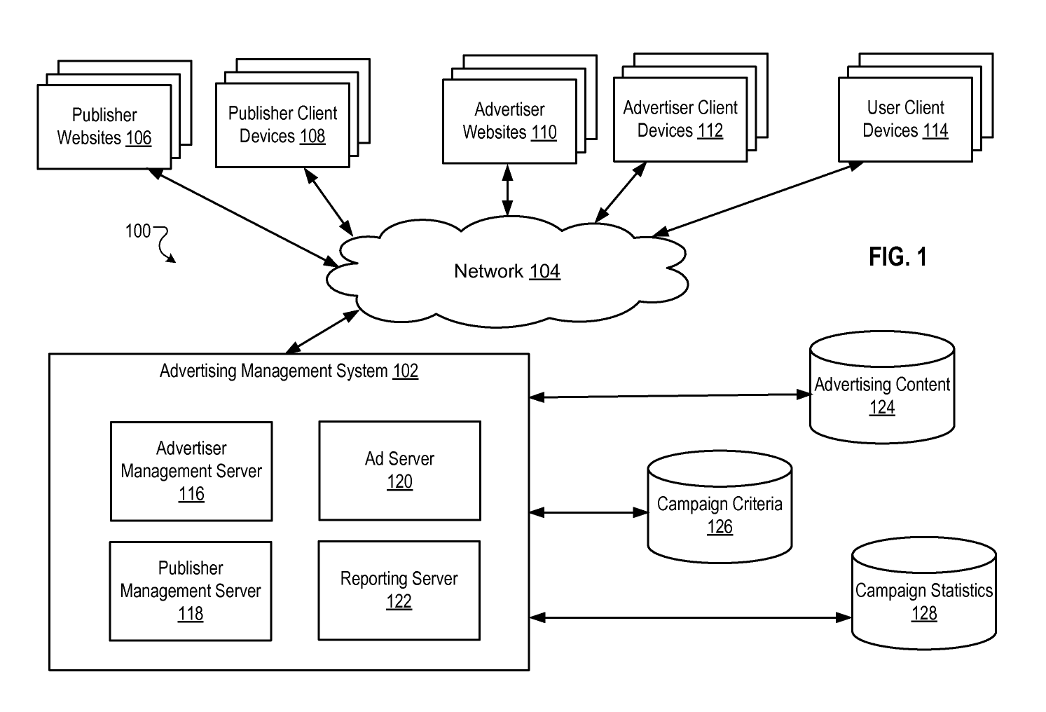

FIG. 1 is a block diagram of an example online advertising environment 100. The online advertising environment 100 utilizes an advertising management system 102 to facilitate the sale and purchase of online advertising opportunities between publishers and advertisers.

The online advertising environment 100 includes a computer network 104, such as a local area network (LAN), wide area network (WAN), the Internet, or a combination thereof, connecting publisher websites 106, publisher client devices 108, advertiser websites 110, advertiser client devices 112, user client devices 114, and the advertising management system 102. The advertising management system 102 further has access to an advertising content store 124, a campaign criteria store 126, and a campaign statistics store 128.

Each publisher website 106 has one or more webpage resources associated with a domain name, and each publisher website 106 is hosted by one or more servers. An example website is a collection of webpages formatted in hypertext markup language (HTML) that can contain text, images, multimedia content, and programming elements, such as scripts. Each publisher website 106 is maintained by a publisher, e.g., an entity that manages and/or owns the website.

Publisher client devices 108, advertiser client devices 112, and user client devices 114 are electronic devices that are under the control of users and are capable of requesting and receiving data over the network 104. A client device typically includes a user application, such as a web browser, to facilitate the sending and receiving of data over the network 104.

The advertising management system 102 facilitates the sale and purchase of advertising opportunities between publishers 106 and advertisers 110. The advertising management system 102 includes components such as an advertiser management server 116, a publisher management server 118, an ad server 120, and a reporting server 122.

The advertiser management server 116 provides user interfaces for advertisers (e.g., using advertiser client devices 112) to define advertising campaigns and ad groups, submit advertising content, and specify various targeting and/or ad placement criteria for the advertising content in each advertising campaign and/or ad group. The advertising content is stored in the advertising content store 124 and the targeting and ad placement criteria are stored in the campaign criteria store 126. For each ad group or campaign, the advertisers can also specify bids for ad slots associated with particular keywords through the interface provided by the advertiser management server 116. Advertisers' bids as well as other campaign related preferences are also stored in the campaign criteria store 128.

The publisher management server 118 provides an interface for publishers (e.g., using publisher client devices 108) to specify ad slots available on the publisher's online properties. For example, the publishers can specify the cost, type, dimensions, and targeting criteria (e.g., keywords associated with the content of the online properties) for each ad slot. The publisher management server 118 provides scripts or references to scripts to the publishers according to the specifications of the ad slots.

Each publisher 106 can insert scripts (e.g., those provided by the publisher management server 118) into its webpages or content items. When the webpages and content items are downloaded to a user client device 114, the scripts are executed (either locally on the user client device 114 or remotely at a server of the advertising management system 102) to generate one or more ad requests to the advertising management system 102. The ad server 120 of the advertising management system 102 responds to the ad requests by sending advertisements to the requesting user client device 114 for insertion into appropriate ad slots in the publisher's webpages or content items as rendered on the requesting user client device 114. The advertisements can include embedded links to landing pages (e.g., webpages on the advertisers' websites 110) that a user is directed to when the user clicks on the advertisements presented on the publisher's webpages or in the content items.

The ad requests are optionally associated with user characteristics (e.g., user's age, gender, income, language preferences, and so on) and advertising context (e.g., keywords associated with webpage content, location, local time of ad request, and so on). Various user privacy measures are implemented to remove personally identifiable information from the user characteristics data. The ad server 120 can select advertisements from the advertising content store 124 for each ad request based on a match between an advertiser's campaign criteria in the campaign criteria store 128 and the user characteristics and advertising context associated with the ad request.

Matching of the publisher keywords specified in the publisher's targeting criteria and the advertiser keywords specified in the advertiser's targeting criteria is one primary method of selecting an advertisement for an ad slot. Typically, exact match of two keywords is preferred over a partial match, and an exact match by keywords can be given more weight than matches based on other targeting criteria. The matching between advertising content and ad slots can be based on additional factors as well. For example, an advertiser can specify an audience interest category, a page level category, and/or specific placements (e.g., publisher URLs), along with the keywords, for its ad groups and ad campaigns. In some implementations, in addition or alternative to the publisher keywords specified by the publishers, the advertising management server can scan the publisher's webpages to determine additional publisher keywords and/or content categories associated with the publisher's webpages.

The advertisements provided after a successful match, and optionally user responses (e.g., click-throughs, conversions, and so on) to the advertisements, can be tracked by various tracking mechanisms (e.g., tracking cookies, pixel callbacks, etc.), sent back to the advertising management system 102, and stored in the campaign statistics store 128. The tracking is enabled by various user opt-in processes. The reporting server 122 provides user interfaces for advertisers and publishers to review reports on the campaign statistics in various formats. Performance of particular keywords, ad groups, and campaigns can be measured based on various performance metrics, such as cost per action (e.g., click or conversion), conversion length (e.g., number of clicks between initial impression and conversion), and so on.

### II. An Example Account Management Tool

An account management tool can be employed by an advertiser to create and manage a large number of online advertising campaigns for various products and services that the advertiser offers. The account management tool can be made available to the advertiser either through an online interface provided by the advertiser management server 116 or as a account management software application installed and executed locally at the advertiser's client devices 112. The online interface and/or the locally executed account management software application can be used for downloading existing account data from the advertiser management server 116 and for uploading new and/or modified account data to the advertiser management server 116.

The advertiser can create and manage multiple advertising campaigns using the account management tool offered by the advertiser management server 116. The advertiser can further specify multiple ad groups under each ad campaign, and specify respective advertisements, budgets, keywords, and other targeting and/or ad placement criteria for each of the ad groups. Typically, the advertising account can be abstracted into a hierarchical structure. For example, the advertising account can include one or more ad campaigns, each ad campaign can include one or more ad groups, and each ad group can include one or more advertisements and keywords.

To create a new ad campaign, a user can first specify values for the campaign level advertising parameters of the ad campaign. The campaign level advertising parameters include, for example, a campaign name, a preferred content network for placing ads, a budget for the ad campaign, start and end dates for the ad campaign, a schedule for ad placements, a targeted language, and targeted geographical locations. Other campaign level advertising parameters includes, for example, a payment scheme such as a cost-per-click (CPC), cost per thousand impressions (CPM), cost-per-action (CPA), and so on.

For the ad campaign, the user can further define one or more ad groups. An ad group contains one or more advertisements which target a particular set of keywords, ad placements, or both. Ad groups under the same campaign can share the same campaign level advertising parameters, but have tailored specifications for particular ad group level advertising parameters, such as keywords, bids for keywords, budget, and so on.

Generally, an advertiser can create different ad groups to have more focused targeting on different product lines or services. For example, different sets of keywords specific to the different product lines or services can be used for the different ad groups. Sometimes, different ad groups can also target different market segments and/or demographic characteristics. Keywords specific for the different market segments and/or demographic characteristics can be included in the different ad groups.

To create a new ad group, the user can first specify values for the ad group level advertising parameters of the ad group. The ad group level advertising parameters include, for example, an ad group name or ad group theme, and various bids for different ad placement opportunities (e.g., automatic placement, advertiser managed placement, etc.) or outcomes (e.g., clicks, impressions, conversions). An ad group name or ad group theme can be one or more terms that the user can use to concisely capture a topic or subject matter that the ad group is targeting. For example, a car dealership can create a different ad group for each brand of vehicles it carries, and may further create a different ad group for each model of vehicles it carries. Examples of the ad group themes that the car dealership can use include, for example, “Ford sports car” “Ford 4×4,” “Toyota sedan,” “Ford truck,” “Ford hybrid,” “Toyota hybrid,” and so on.

After creating the campaign and one or more ad groups under the campaign, the advertiser can specify and add one or more keywords and advertisements to each ad group. The keywords are typically terms that are relevant to the product or services that the user wishes to promote for the ad group. Each keyword can include one or more terms. For example, the car dealership may include “sports car,” “V-6 engine,” “four-wheel drive,” “fuel efficiency,” and so on as keywords for its ad groups and ad campaigns. In some cases, negative keywords can be specified by the advertiser to avoid ad placement on certain search result webpages and/or content webpages matching those negative keywords. The advertiser can also specify whether exact match of keywords are required for ad placements on the content network.

In addition to keywords, for each ad group, the advertiser can also specify a number of advertisements for selection by the ad server when an advertising opportunity becomes available that matches the budget, ad schedule, maximum bids, keywords, and other targeting criteria specified for the ad group. Different types of ads can be included in an ad group, such as a text ad, an image ad, a local business ad, a mobile ad, and so on.

Other aspects of the ad group can be defined in terms of various advertising parameters and specified by user-entered values or default values for those various advertising parameters. After the advertiser has specified all the required advertising parameters for each level and aspect of the ad campaign(s), the advertising campaign data (e.g., including the campaign structure and the advertising parameters on each level within the campaign structure) can be uploaded to the advertiser management server 116. The advertising campaign can be created and activated according to the advertising campaign data specified by the advertiser.

### III. Ad Group Generation Using Aggregated Sequential Search Queries

### III.A An Example Advertiser Management Server

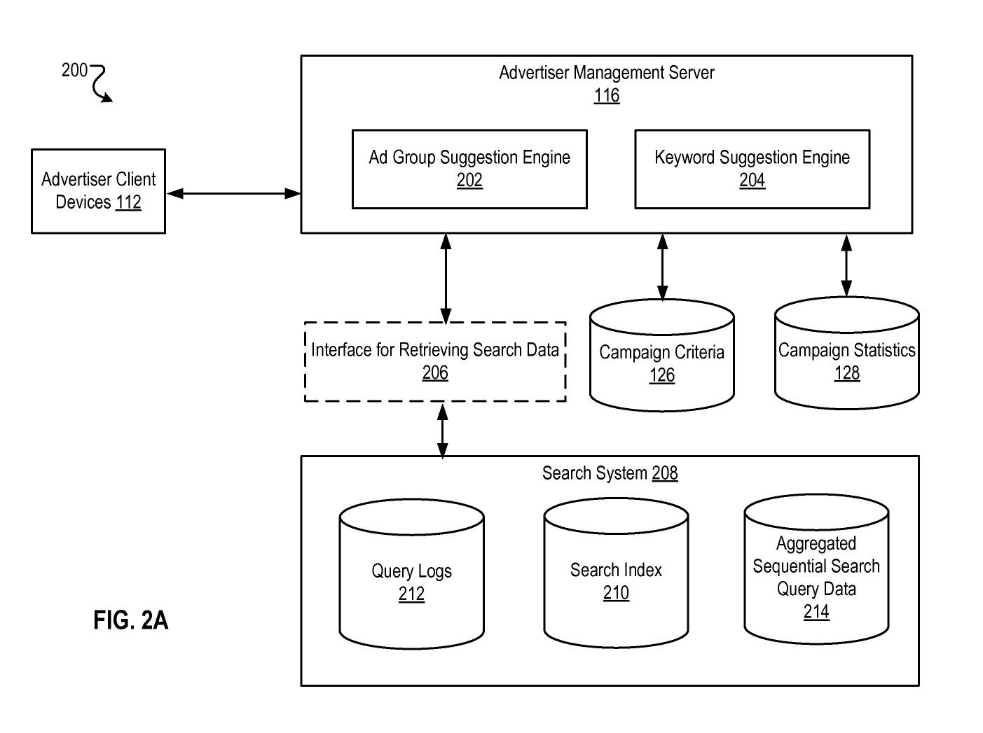

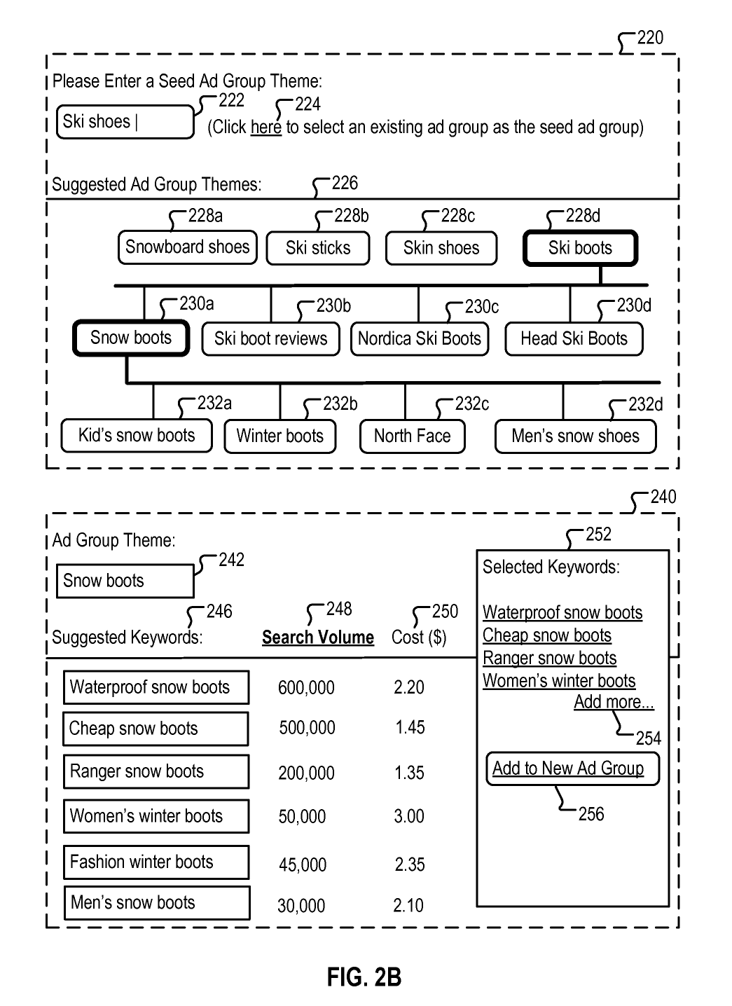

FIG. 2A shows an example environment 200 in which the advertiser management server 116 can operate to create ad groups based on aggregated sequential search queries. In some implementations, the advertiser management server 116 can include an ad group suggestion engine 202 and a keyword suggestion engine 204. The ad group suggestion engine 202 can obtain the aggregated sequential search queries from a search system 208 (e.g., through an interface 206 provided by the search system 206). In some implementations, the aggregated sequential search queries can be obtained through other means or other intermediate components.

In the example environment 200, the search system 208 can include a search engine and is capable of receiving user submission of search queries over the Internet and providing search results (e.g., links to webpages and other content items) in response to the received search queries. Each search query can include one or more terms that are used by the user to describe his or her information needs. For example, a user hoping to find a guacamole recipe can enter search terms such as “guacamole,” “avocado recipe,” “guacamole recipe,” or “guacamole with tomato” in a search query. The search system 208 can identify content (e.g., webpages) relevant to the search terms based on a search index 210, and return to the user the most relevant search results (e.g., as links to the relevant content) in a result webpage.

The search system 208 can provide search services to a large number of people over an extended period of time. The search system 208 can also keep track of the queries submitted from the users of the search system 208 in query logs 212. The query logs 212 can include information about each query submission, such as the search terms in the search query, and the time and location of the query submission, and so on. Various mechanisms are implemented to maintain user privacy, such as anonymizing the search data and removing personally identifiable information from the query logs. Active user opt-in measures can be implemented to enable the tracking and storage of the query submissions.

In some implementations, each query submission can be associated with a respective search session during which multiple search queries were submitted by the same user. Multiple search queries can be associated with the same search session if the queries were submitted by the same user within the time period associated with the search session. A search session can be identified by a client device identifier (e.g., a user identifier or an IP address associated with a client device from which the search queries were submitted). The search session can also be associated with a time period in which continued user interaction (e.g., query submissions and result browsing) between the client device and the search system 208 can be detected. The order by which queries are submitted in a search session can be determined based on a timestamp associated with each query submission. In some implementations, a search session can be identified by a cookie, and the termination of the search session is indicated by the expiration of the cookie.

The search system 208 can process the information in the query logs 212 and generate aggregated sequential search query data 214. The aggregated sequential search query data 214 include information that identify a group of most popular sequential search queries for a given search query. A sequential search query for a given search query is a search query that has been submitted in sequence with (i.e., either immediately before or immediately after) the given search query during the same search session associated a user. For example, for three queries Q1, Q2 and Q3 submitted in succession without intervening queries during a search session, queries Q1 and Q2 and sequential search queries of each other, as are search queries Q2 and Q3. A popular sequential search query for a given search query is a search query that has been submitted in sequence with the given search query in respective search sessions of many users.

In some implementations, the search system 208 can rank the sequential search queries for a given search query based on the frequency that the sequential search queries appear in sequence with the given search query in a respective search session of a user, and the aggregated sequential search queries for the given search query are the top ranking sequential search queries of the given search query. In some implementations, the aggregated sequential search queries of the given search query includes sequential search queries that have been submitted in sequence with the given search query by more than a threshold number of people (e.g., 1,000 people). In some implementations, certain sensitive queries, such as queries that include inappropriate or sensitive content, are filtered out and excluded from the sequential search queries under consideration.

In some implementations, the search engine 208 can provide the list of aggregated sequential search queries for a given search query in response to requests made through the interface 206. For example, a user can explore through the interface 206 what kind of search queries other users have submitted immediately before or after submitting a particular search query.

Aggregated sequential search query data is useful in identifying closely related terms, phrases, and concepts. The relationships expressed in the aggregated sequential search query data 214 are not identified based on the similarity of the search terms or clustering of words and concepts based on analysis of text in webpages or literatures. Instead, the relationships emerge from the collective behavior of search engine users during searches. The collective behavior of the search engine users reflect how people cognitively link concepts based on their own knowledge and based on the new information acquired during the continued searches.

The ad group suggestion engine 202 can use the aggregated sequential search queries to generate new and related ad groups for a given seed ad group. First, a seed ad group theme can be deduced from the seed ad group. The seed ad group theme can be a name of the seed ad group or a best performing keyword of the seed ad group. In some implementations, the seed ad group theme can be a uniform resource locator (URL) of the advertiser's webpage, or a keyword or anchor text obtained from a scan of the publisher's webpage. The seed ad group theme includes one or more terms. In cases that a URL is used as the ad group theme, the URL can be treated as a single term. In some implementations, the URL can be broken into several meaningful terms by a textual analysis of the URL string.

The terms of the seed ad group theme are used to obtain aggregated sequential search queries of a seed search query containing the same terms. The obtained aggregated sequential search queries or a subset thereof can be provided to the user by the ad group suggestion engine 202 as suggested ad group themes for generating new ad groups related to the seed ad group.

In some implementations, one or more of the aggregated sequential search queries of the seed search query can be used as new seed search queries to obtain additional aggregated sequential search queries. One of more of the additional aggregated sequential search queries can also be used as new seed search queries to obtain even more aggregated sequential search queries. All of the aggregated sequential search queries that can be obtained from the initial seed query (e.g., either directly from the initial seed search query or indirectly through one or more intermediate aggregated sequential search queries), can be used as suggested ad group themes for generating new ad groups related to the initial seed ad group.

In some implementations, the keyword suggestion engine 204 can provide a collection of keywords for each new ad group. The keyword suggestion engine 204 can suggest the keywords based on, for example, the terms of the ad group theme. Various known keyword suggestion techniques can be used to generate the suggested keywords. For example, related keywords can be provided based on linguistics, similarity of terms, clustering of words of topic categories, and so on.

In some implementations, the suggested keywords can be ranked in terms of various criteria, such as search volume, average cost, and so on. In some implementations, search volume of a query can be a number of searches performed using the query in a given period of time. Average cost of a keyword can be an average cost that advertisers are willing to bid for the keyword in advertising in the content network or the search network. Other criteria can include, for example, the performance of the same keyword in the search network. In some implementations, the performance measures can be based on data obtained from the query logs 212 and the campaign statistics database 128. A subset of suggested keywords can be used as the keywords for the new ad group.

In some implementations, the identification of seed ad groups, the retrieval of sequential search queries for the seed ad group themes, the selection of suggested ad group themes for new ad group generation, the selection of keywords for each new ad group can be performed by a user through an interface provided by the advertiser management server 116, such as the example user interface shown in FIG. 2B.

In FIG. 2B, an interface 220 can be presented to a user by the advertiser management server, for example. The interface 220 can include an input area (e.g., text box 222) for the user to manually enter one or more terms that is to be used as the seed ad group theme. In some implementations, the interface 220 can provide a means (e.g., link 224) allowing the user to select an existing ad group as the seed ad group, and use the theme of the selected ad group as the seed ad group theme.

In this example, the user has entered a seed ad group theme “ski shoes” in the text box 222, and the user interface 220 can present a number of suggested ad group themes in an area 226. The suggested ad group themes are based on the aggregated sequential search queries that can be obtained from a seed search query having the same terms as the seed ad group theme. The suggested ad group themes can be provided by the ad group suggestion engine 202, for example. The suggested ad group themes can be presented in a hierarchy, for example. With the seed ad group theme as the root node of the hierarchy, the child nodes immediately below the root nodes (e.g., child nodes 228a-d) represent suggested ad group themes that are based on aggregated sequential search queries of the seed search query (e.g., “ski shoes”).

The user can select a suggested ad group theme in the first level child nodes (e.g, child node 228d “ski boots”) to see additional suggested ad group themes (e.g., represented by child nodes 230a-d) generated from the selected ad group theme (e.g., represented by the child node 228d). Each time the user selects a suggested ad group theme (e.g., represented by child node 230a) in the hierarchy, additional suggested ad group themes originating from the selected ad group theme can be presented, where the additional suggested ad group themes (e.g., represented by child nodes 232a-d) are based on the aggregated sequential search query of a new seed search query that has the same terms as the selected ad group theme (e.g., represented by child node 230a). In some implementations, the user can select multiple ad group themes on each level of the hierarchy, and several branches of the hierarchy can be expanded in the interface 220.

In some implementations, after the user has completed selection of the suggested ad group themes for new ad groups, another user interface 240 can be presented for the user to select keywords for each of the new ad groups. In some implementations, user interface 240 can be explicitly invoked by the user, e.g., by selecting a suggested ad group theme in the interface 220, and then select an “add keywords” user interface element (not shown) in the user interface 240.

In some implementations, the user interface 240 can include an input field (e.g., text box 242) for entering an ad group theme (e.g., a selected suggested ad group theme). This field can be filled by the user manually, or automatically populated based on the currently selected ad group theme. Suggested keywords can be presented to the user in an area 246. These suggested keywords can be provided by the keyword suggestion engine 204, for example. In some implementations, the suggested keywords can be presented along with data for one or more performance measures (e.g., search volume, average cost, and so on). The user can sort the suggested keywords by selecting a criterion on the interface 240 (e.g., search volume 248, cost 250, and so on). In this example, the suggested keywords are sorted according to decreasing search volume.

In some implementations, one or more suggested keywords can be selected for the new ad group that is to be generated based on the suggested ad group theme shown in input field 242. In some implementations, the user can manually select one or more of the suggested keywords in the area 246. In some implementations, a predetermined number of top ranked suggested keywords can be automatically selected and shown in the suggested keyword area 252. In some implementations, the user can choose to add additional keywords by selecting the link 254. Once the user is satisfied with the keywords selected for the ad group theme, the user can proceed to add the keywords to the new ad group that is to be created based on the ad group theme, for example, by selecting the user interface element 256.

User interfaces 220 and 240 are mere examples. Other features and user interface elements can be provided. Not all features and elements presented are necessary.

In some implementations, one or more steps of the ad group generation can be automated, and performed by the advertiser management server 116 or a component thereof according to various user or system specified rules and criteria. For example, the selection of a seed ad group can be performed periodically or upon detection of a successful ad group among existing ad groups. An ad group having good performance can be expanded into additional new ad groups that are closely related to the successful ad group. Alternatively, a broad ad group theme that has shown poor performance can be broken up into multiple new ad groups to increase to likelihood of subsequent identification of a better performing ad group theme among the new ad groups.

For another example, the aggregated sequential search query data 214 can be monitored by the user or the ad group suggestion engine 202 from time to time to detect emergence of new aggregated sequential search queries for a successful seed ad group. Similarly, the aggregated sequential search query data 214 can be monitored for the demise of an old aggregated sequential search query for a successful seed ad group. Newly emerged aggregated sequential search queries can be used to create new ad groups, and ad groups based on disappeared aggregated sequential queries can be deactivated. By such monitoring the set of ad groups in operation can be updated based on the evolution of consumer trends reflected in the aggregated sequential search query data 214.

In some implementations, the ad group suggestion engine 202 and/or the keyword suggestion engine 204 can dynamically update the ad groups and keywords for each ad group based on the performance of the ad groups and keywords. In some implementations, the ad group suggestion engine 202 and/or the keyword suggestion engine 204 can also dynamically update the ad groups and keywords for each ad group based on the evolving search volumes of the keyword used as the seed search query and the keywords in each ad group.

The advertiser management server 116 can store the ad group and keyword information in the campaign criteria data store 126. When the ad groups and/or keywords are updated by the user or by the advertiser management server automatically, the information stored in the campaign criteria data store 126 can be updated as well.

### III.B Example Processes for Ad Group Generation Using Aggregated Sequential Search Queries

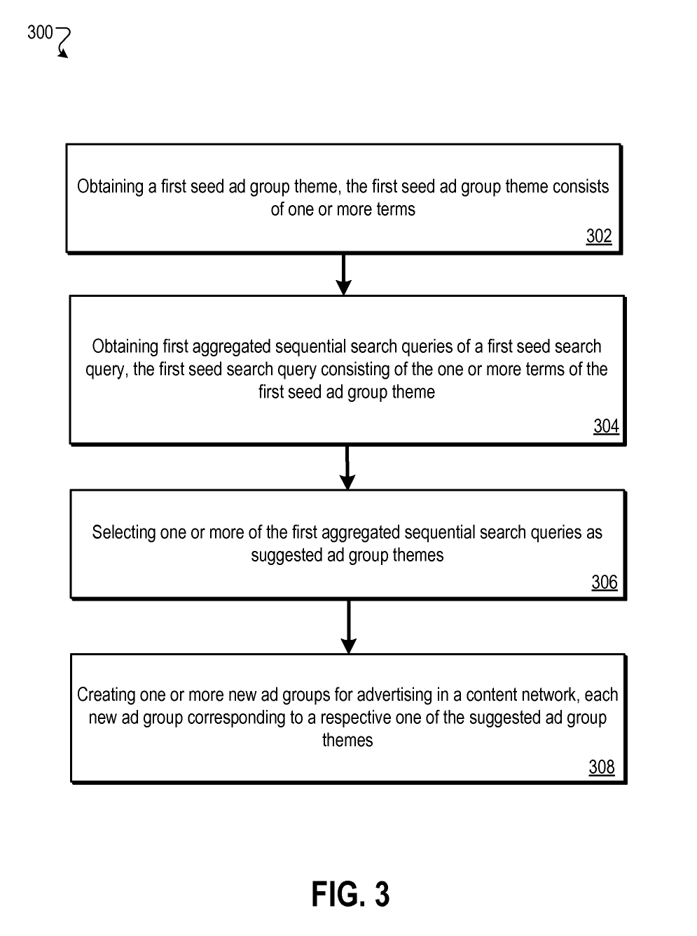

FIG. 3 is a flow diagram of an example process 300 for generating ad groups based on aggregated sequential search queries. The process 300 can be implemented by the advertiser management system 116, for example.

The process 300 starts when a seed ad group theme is obtained, where the seed ad group theme consists of one or more terms (302). In some implementations, an ad group theme is one or more terms that concisely describe a specific topic relevant for content targeting. For example, a small law firm specializing in intellectual property law can have an ad group having an ad group theme “patent law” and another ad group having an ad group theme “copyright law.” In some implementations, the theme of an ad group can be a name or a keyword (e.g., a top-performing keyword) of the ad group. In some implementations, the seed ad group theme does not have to be the theme of an existing ad group.

Given the seed ad group theme, aggregated sequential search queries of a seed search query can be obtained, where the seed search query includes the one or more terms of the seed ad group theme (304). Each of the aggregated sequential search queries is a respective search query that has been submitted in sequence with the seed search query to a search system by more than a threshold number of users during a respective search session associated with each user. In some implementations, the aggregated sequential search queries of the seed search query are the top-ranked sequential search queries of the seed search query in terms of the frequency of the queries' co-occurrences with the seed search query in individual user search sessions.

In some implementations, the requirement for strict adjacency between two search queries within a search session can be relaxed slightly, and a gap of one or two intermediate queries may not disqualify the two search queries from being sequential search queries of each other. For example, if a user submitted three queries (A, B, and C) during a search session, the third search query (e.g., “C”) can be a sequential search query of the first search query (e.g., “A”) submitted during the search session. If the query A appears in more than a threshold number of search sessions within one query away from the query C, then query A and query C can be deemed aggregated sequential search queries of each other. The size of the gap between sequential search queries can be determined heuristically.

After the aggregated sequential search queries of the seed search query has been obtained, one or more of the aggregated sequential search queries can be selected as suggested ad group themes (306). In some implementations, the selection can be made by a user. In some implementations, the selection can be made based on some predetermined, user-specified or system default rules.

For example, the rules can state that only aggregated sequential search queries satisfying a particular search volume requirement qualified as the suggested ad group themes. For another example, the rule can also state that only aggregated sequential search queries that share at least one common term with the seed search query can be selected as the suggested ad group themes. Other rules and criteria for selecting aggregated sequential search queries as suggested ad group themes are possible.

Once the suggested ad group themes are selected, one or more new ad groups can be created for advertising in a content network, where each new ad group corresponds to a respective one of the suggested ad group themes (308). In some implementations, the user may be prompted to enter the keywords for each new ad group, and specify values for other ad group level advertising parameters. Once the keywords and other advertising parameters are entered and the ad groups are created, the ad group information can be stored in the campaign criteria data store 126 of the adverting management system 102, and used by the ad server 120 in ad selection and delivery.

In some implementations, the advertiser management server 116 can obtain the one or more terms of the seed ad group theme from a user or automatically based on some user-specified or system default rules. In some implementations, both user-specified seed ad group themes and automatically generated seed ad group themes can be used to in generating new ad groups for an ad campaign.

For example, the advertiser management server 116 can provide a user interface allowing the advertiser to manually enter the one or more terms of the seed ad group theme. In some implementations, the advertiser management server 116 can receive from the user and through an interface of a campaign management environment, the one or more terms of the seed ad group theme. In some implementations, the user can manually select an existing ad group as a seed ad group, and the name of the selected ad group or a keyword from the selected ad group can be used as the seed ad group theme. In some implementations, if a keyword from the selected ad group is used as the seed ad group theme, the keyword can be selected based on a performance criterion (e.g., number of successful matches to publisher content) or manually selected by the user. In some implementations, the advertiser management server 116 can present the existing ad groups and their respective past performances to the user, so that the user can identify which ad group he or she would like to designate as the seed ad group. In some implementations, the ad groups can be presented in an order according to their relative performances (e.g., average cost per action, total ad impressions, and so on).

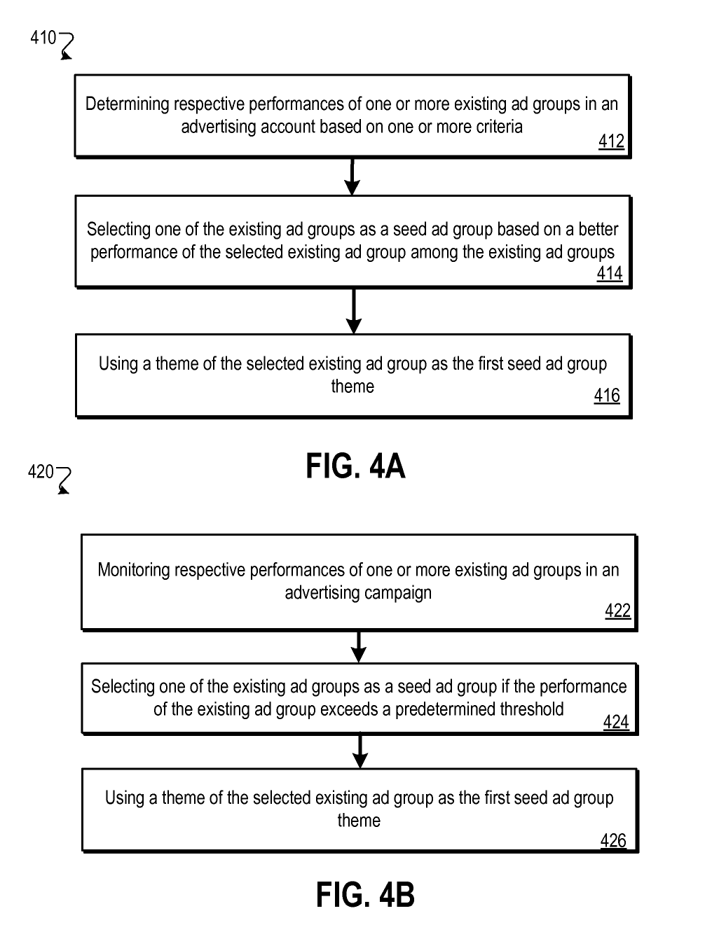

In some implementations, the advertiser management server can obtain the seed ad group theme automatically by scanning the advertiser's webpages and extract anchor text or keywords that appear frequently in the advertiser's webpages. In some implementations, the advertiser management server can analyze the URLs of the advertiser's webpages and use terms appearing in the URL as the seed ad group theme. In some implementations, the advertiser management server 116 can obtain the seed ad group theme automatically from existing ad groups based on one or more performance criteria. As shown in FIG. 4A, in an example process 410, the advertising management server can determine respective performances of one or more existing ad groups in an advertising account based on one or more criteria (412). The one or more criteria can include, for example, the average cost per conversion, the average cost per click, the average number of successful content matches per unit time period (e.g., a day, a month, etc.), the average percentage of daily advertising budget spent, and so on. The performance data can be determined based on the campaign statistics stored in the campaign statistics data store 128, for example.

After the performances of the one or more existing ad groups are determined, one of the existing ad groups can be selected as a seed ad group based on a better performance of the selected existing ad group among the existing ad groups (414). The better performance can be a lower average cost per conversion, a lower average cost per click, a higher average number of successful content matches per unit time period (e.g., a day, a month, etc.), a higher average percentage of daily advertising budget spent, or a combination of one or more of the above, for example. A theme of the selected existing ad group can be used as the first seed ad group theme (416). The theme of the selected ad group can be a descriptive name of the selected ad group, or a keyword from the selected ad group, for example.

In some implementations, the advertiser management server 116 can continuously monitor the respective performance of the existing ad groups to discover potential seed ad groups for new ad group generation. As shown in FIG. 4B, in an example process 420, respective performances of one or more existing ad groups in an advertising campaign can be monitored (422). At least one of the existing ad groups can be selected as a seed ad group if the performance of the existing ad group exceeds a predetermined threshold (424). Then, a theme of the selected existing ad group can be used as the seed ad group theme (426).

In some implementations, the predetermined threshold can be a threshold indicating good performance of the existing ad group. For example, the performance threshold indicating good performance can be a low average cost per conversion, a low average cost per click, a high number of successful content matches per unit time period (e.g., a day, a month, etc.), a high percentage of daily advertising budget spent, or a combination of one or more of the above. The exact values of the thresholds indicating good performance can be determined heuristically. Selecting a well performing ad group as the seed ad group and expand on it can help maximizing a particular subsector of product and services that has remaining unexplored market and advertising potential.

In some implementations, the predetermined threshold can be a threshold indicating poor performance of the existing ad group. For example, the threshold indicating poor performance can be a high average cost per conversion, a high average cost per click, a low average number of successful content matches per unit time period (e.g., a day, a month, etc.), a low average percentage of daily advertising budget spent, or a combination of one or more of the above. The exact values of the threshold indicating poor performance can be determined heuristically as well. Selecting a poor performing ad group as the seed ad group and splitting it into multiple new and more specific ad groups can help improve the success rate of content matching in each of the more specific ad groups. Splitting the poor performing ad group into multiple new ad groups can also help separating some sub-themes in the original ad group that are more likely to succeed from the other sub-themes in the ad group that are less likely to succeed.

In some implementations, while continuously monitoring the respective performance of the existing ad groups, poor performing ad groups can be disabled or removed from the ad campaign and replaced with new, and potentially better performing ad groups generated based on sequential search queries. In some implementations, new ad groups can be generated based on sequential search queries of a seed search query having identical terms as a seed ad group theme. Each new ad group can be activated for a given trial period. If the new ad group's performance exceeds a predetermined threshold, the new ad group can be kept in operation. If the new ad group's performance does not meet a minimum threshold requirement, the new ad group can be disabled and replaced with another new ad group that are generated based on additional sequential search queries of other seed search queries, for example.

In some implementations, after the one or more terms of the seed ad group theme are obtained, aggregated sequential search queries of a seed search query can be obtained, where the seed search query consists of the one or more terms of the seed ad group theme. In some implementations, after new ad groups have been generated using aggregated sequential search queries, the aggregated sequential search queries of the seed search query can be continuously or periodically monitored for emergence of new aggregated sequential search queries for the seed search query.

The emergence of the new aggregated sequential search queries can be an indication of a new trend and/or new cognitive relationship between two concepts that has recently developed among consumers. By monitoring the aggregated sequential search queries of the seed search query, additional new ad groups can be created based on newly emerged aggregated sequential search queries of the seed search query.

In some implementations, disappearance of an aggregated sequential search query of a seed search query can indicate a decline in popularity and/or vanishing cognitive relationship between two concepts among consumers. By monitoring the aggregated sequential search queries of the seed search query after ad groups have been created based on the aggregated sequential search queries, some ad groups can be removed or disabled if the particular aggregated sequential search queries used to create those ad groups no longer qualify as aggregated sequential search queries for the seed ad group.

In some implementations, an update on the aggregated sequential search queries of the seed search query can be obtained periodically, and new ad groups can be generated based on the aggregated sequential search queries have been submitted to the search system within a most recent time period of a predetermined duration (within the past 3 months, for example).

In some implementations, after the terms of a seed ad group theme has been obtained, either through user specification or by system suggestion, the advertiser management server 116 can obtain the aggregated sequential search queries of a seed search query having those terms. The advertiser management server 116 can allow the user to review and explore further aggregated sequential search queries of one or more of the aggregated sequential search queries of the seed search query.

In some implementations, the advertiser management server 116 can provide a user interface that allows a user to explore the aggregated sequential search queries that can be obtained from a seed search query, both directly from the seed search query and indirectly via one or more intermediate aggregated sequential search queries.

In some implementations, the aggregated sequential search queries that can be obtained from the seed search query can be presented in a hierarchical structure, such as a tree structure, that can be continuously expanded and explored by the user to show additional aggregated sequential search queries of the search queries already shown in the hierarchical structure.

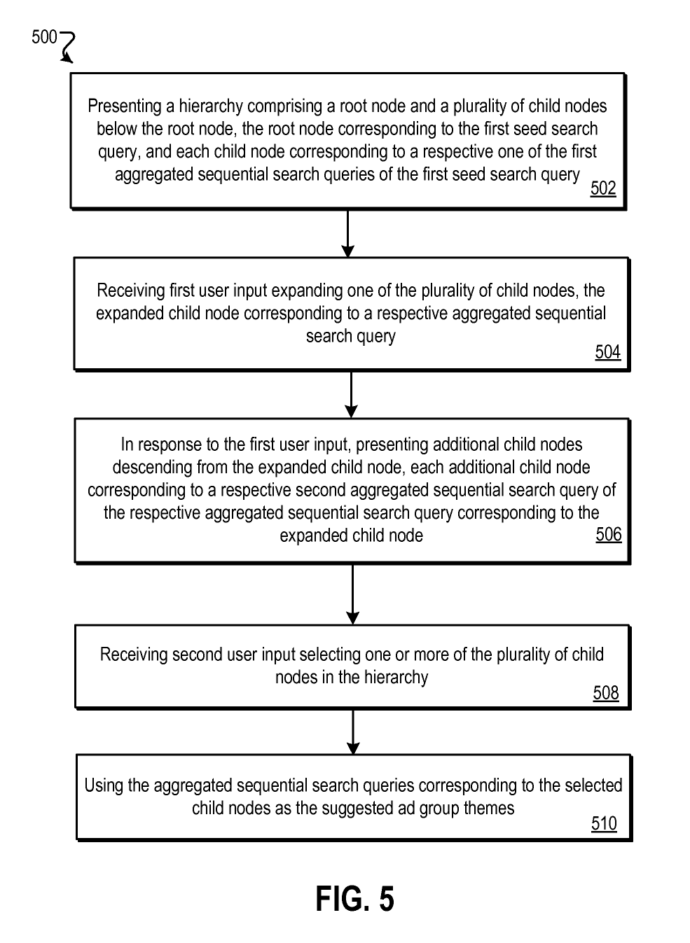

In an example process 500 shown in FIG. 5, a hierarchy can be presented in a user interface (502). The hierarchy can include a root node and a plurality of child nodes below the root node, where the root node corresponds to the first seed search query, and each child node corresponds to a respective one of the aggregated sequential search queries of the first seed search query. In some implementations, when initially presented, the hierarchy can show only the aggregated sequential search queries of the seed search query, i.e., only the root level and the child level immediately below the root level of the hierarchy.

In some implementations, the user can select and expand a child node to show additional aggregated sequential search queries of the search query represented by the expanded child node. For example, user input expanding one of the child nodes can be received, the expanded child node corresponding to a respective aggregated sequential search query (504). In response to the received first user input, additional child nodes descending from the expanded child node can be presented, where the additional child nodes each corresponds to a respective aggregated sequential search query of the aggregated sequential search query represented by the expanded child node (506). In some implementations, the user can continue to expand newly presented child nodes and be presented with additional levels of child nodes that represent the aggregated sequential search queries of intermediate aggregated sequential search queries that descended from the seed search query.

In some implementations, the user can select the child nodes currently shown in the hierarchy as a suggested ad group theme to generate a new ad group based on the suggested ad group theme. For example, the process 500 can continue where second user input selecting one or more of the plurality of child nodes in the hierarchy can be received (508). After a child node is selected, the aggregated sequential search queries corresponding to the selected child nodes can be used as the suggested ad group themes (510). In some implementations, the user input selecting and expanding a child node can be used as the user's indication for choosing the expanded child node as a suggested ad group theme.

In addition to selecting the aggregated sequential search queries of the seed search query as the suggested ad group themes, one or more of the aggregated sequential search queries can be used as additional seed search queries to identify additional related themes and topics. The process of exploring the aggregated sequential search queries from a seed search query can continue until the user is satisfied with the total number of ad group themes generated from the aggregated sequential search queries that have been obtained either directly from the seed search query, or indirectly through one or more intermediate aggregated sequential search queries of the seed search query.

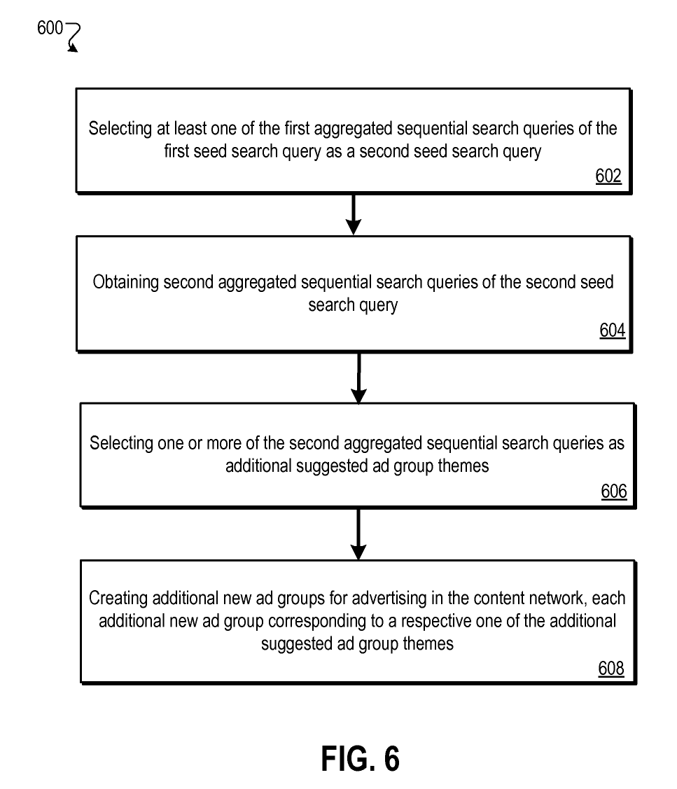

FIG. 6 is a flow diagram an example process 600 for creating additional ad groups based on aggregated sequential search queries that are indirectly obtained from the seed search query (e.g., through an aggregated sequential search query of the seed search query).

In some implementations, the process 600 starts when at least one of the aggregated sequential search queries of the first seed search query is selected and designated as a new, second seed search query (602). Then, aggregated sequential search queries of the second seed search query can be obtained (604). The aggregated sequential search queries of the second seed search query are search queries that have been submitted in sequence with (either immediately before or immediately after) the second seed search query by more than a threshold number of users during a respective search session associated with each user.

As with the aggregated sequential search queries of the initial seed search query, one or more of the second aggregated sequential search queries can be selected as additional suggested ad group themes (606). Additional new ad groups can be created for advertising in the content network, where each additional new ad group corresponds to a respective one of the additional suggested ad group themes (608). The process 600 can be repeated for any other aggregated sequential search queries that have been obtained directly or indirectly from the seed search query, such that even more additional aggregated sequential search queries can be obtained and used as additional ad group themes.

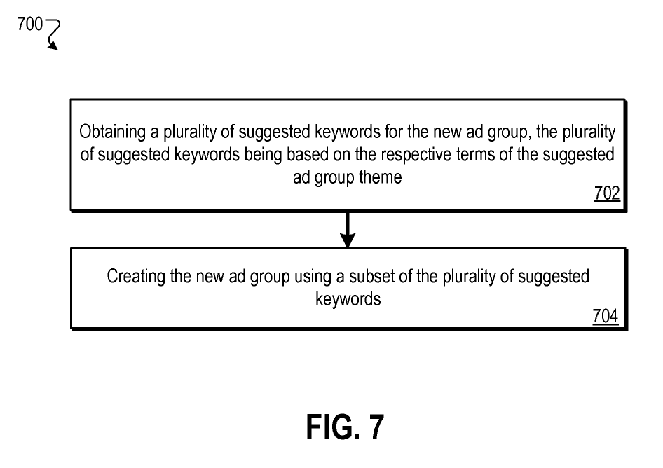

To create an ad group based on an ad group theme, various advertising parameters including keywords need to be specified for the ad group. Keywords in the ad group can be used by the advertising server to match to the keywords that are associated with content and/or ad slots on publisher's properties. FIG. 7 is a flow diagram of an example process 700 for creating new ad groups based on the ad group themes. In the process 700, for each of the one or more new ad groups, a plurality of suggested keywords can be obtained for the new ad group, where the plurality of suggested keywords are provided based on the respective terms of the suggested ad group theme (702). Then, the new ad group can be created using a subset of the plurality of suggested keywords (704).

In some implementations, the plurality of suggested keywords can be presented in an order according to a predetermined criterion. For example, the keywords can be presented in an order of decreasing search volume. For another example, the keywords can be presented in an order of increasing average cost. User input selecting the subset of suggested keywords from the plurality of suggested keywords can be received. Then, the new ad group can be created using the user-selected subset of suggested keywords.

In some implementations, instead of having the user select the subset of keywords for each new ad group, the subset of suggested keywords can be selected based on a predetermined criterion. In some implementations, the predetermined criterion can be a minimum search volume or a maximum cost, for example.

In some implementations, there is an upper limit placed on the number of keywords that each new ad group can have. For example, instead of having many keywords, each ad group only has a small number of keywords focused on a very specific ad group theme. The optimum number of keywords selected for each ad group can be determined heuristically, for example.

In some implementations, the keywords of an ad group can be revaluated from time to time, and poor performing keywords can be replaced by new keywords in the list of suggested keywords that also satisfy the predetermined criterion. The performance of the keywords can be measured based on average cost per action, match success rate, and so on.

The subject matter described in this specification can be implemented as a tool that facilitate user participation in using aggregated sequential search queries to generate new ad groups as well as automated systems that generate ad groups based on predetermined rules without active user participation.

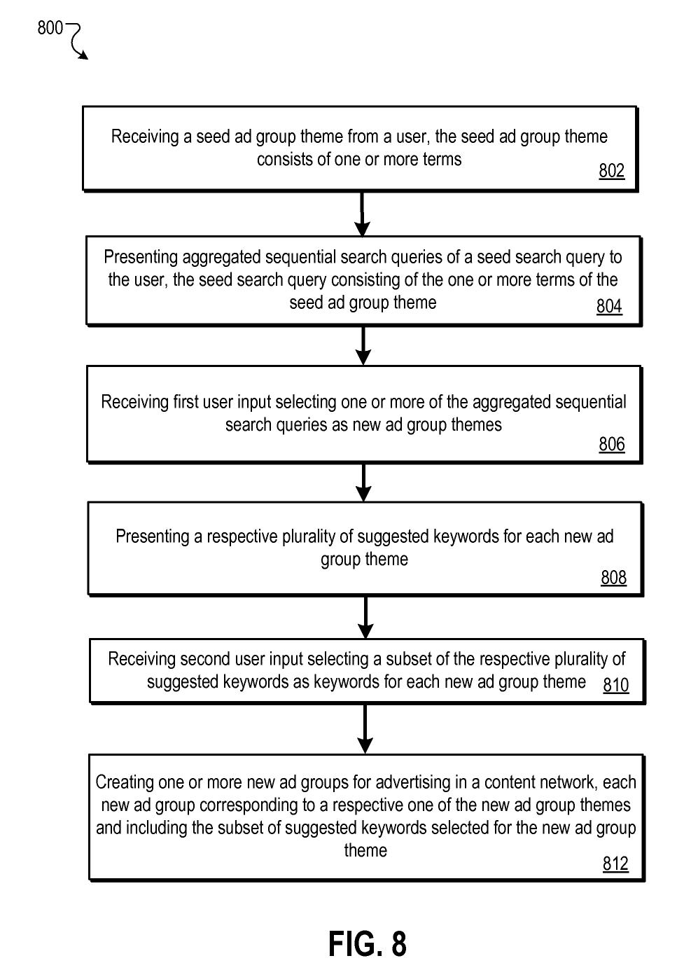

FIG. 8 is a flow diagram of an example process 800 in which a user actively interactive with the advertiser management system 116 in creating the ad groups. The process 800 can start when a seed ad group theme is received from a user, where the seed ad group theme consists of one or more terms (802). Then, aggregated sequential search queries of a seed search query can be presented to the user (804). The seed search query consists of the one or more terms of the seed ad group theme, and each of the aggregated sequential search queries can be a respective search query that has been submitted in sequence with the seed search query to a search system by more than a threshold number of search engine users during a respective search session associated with each search engine user. Then, first user input can be received, the first user input selecting one or more of the aggregated sequential search queries as new ad group themes (806). A respective plurality of suggested keywords can be presented for each new ad group theme (808). Second user input can be received, the second user input selecting a subset of the respective plurality of suggested keywords as keywords for each new ad group theme (810). In the end, one or more new ad groups for advertising in a content network can be created (812), where each new ad group corresponds to a respective one of the new ad group themes and including the subset of suggested keywords for the new ad group theme.

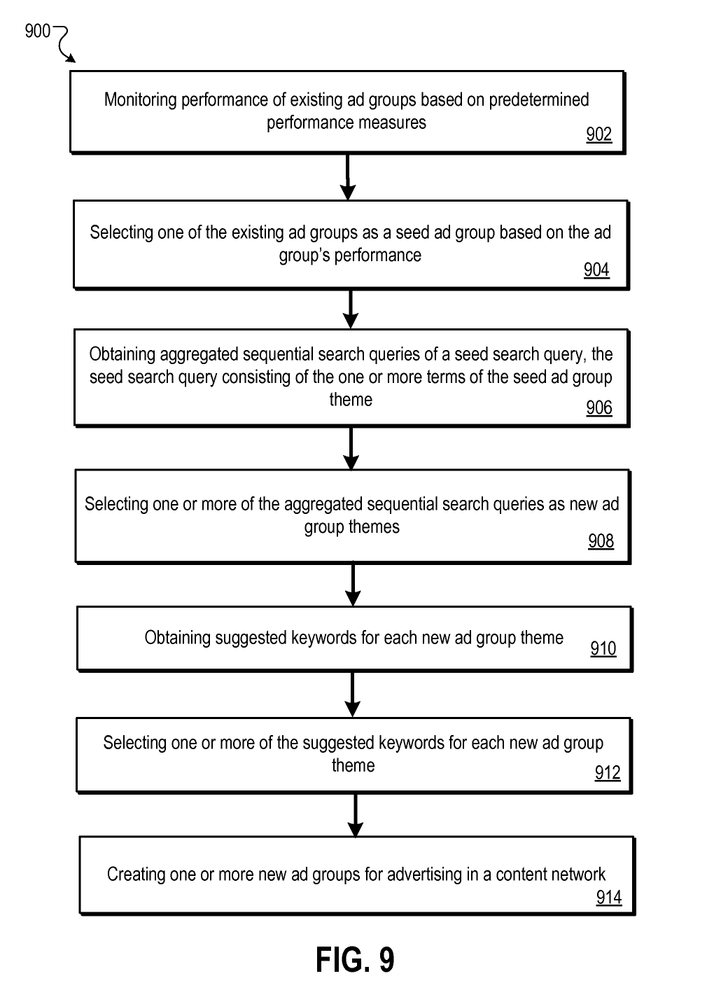

FIG. 9 is a flow diagram of an example process 900 in which ad groups can be created automatically by a system (e.g., the advertiser management server 116) without active interaction with the user for one or more steps of the ad group creation process. The process 900 can start by the advertiser management server monitoring performance of one or more existing ad groups based on one or more predetermined performance measures (902). Then, one of the one or more existing ad groups can be selected as a seed ad group theme based on the ad group's performance (904). Aggregated sequential search queries of a seed search query can be obtained by the advertiser management server (906), where the seed search query consists of the one or more terms of the seed ad group theme. Each of the aggregated sequential search queries can be a respective search query that has been submitted in sequence with the seed search query to a search system by more than a threshold number of users during each user's respective search session. Then, one or more of the aggregated sequential search queries can be selected as new ad group themes (908). Suggested keywords can be obtained for each new ad group theme (910). Then, one or more of the suggested keywords for each new ad group theme can be selected as keywords for inclusions in a new ad group corresponding to the new ad group theme (912). In the end, one or more new ad groups can be created for advertising in a content network, where each new ad group corresponds to a respective one of the new ad group themes and including the selected keywords for the new ad group theme (914).

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method performed by one or more data processing apparatus, comprising:
obtaining a first seed ad group theme, the first seed ad group theme consists of one or more terms;
obtaining first aggregated sequential search queries of a first seed search query, the first seed search query consisting of the one or more terms of the first seed ad group theme, and each of the first aggregated sequential search queries being a respective search query that has been submitted in sequence with the first seed search query to a search system by more than a threshold number of users during a respective search session associated with each user;
selecting one or more of the first aggregated sequential search queries as suggested ad group themes; and
creating one or more new ad groups for advertising in a content network, each new ad group corresponding to a respective one of the suggested ad group themes.

2. The method of claim 1, wherein obtaining the first seed ad group theme further comprises:
receiving, from a user and through an interface of a campaign management environment, the one or more terms of the first seed ad group theme.

3. The method of claim 2, further comprising:
presenting a hierarchy comprising a root node and a plurality of child nodes below the root node, the root node corresponding to the first seed search query, and each child node corresponding to a respective one of the first aggregated sequential search queries of the first seed search query;
receiving first user input expanding one of the plurality of child nodes, the expanded child node corresponding to a respective aggregated sequential search query; and
in response to the received first user input, presenting additional child nodes descending from the expanded child node, each additional child node corresponding to a respective second aggregated sequential search query of the respective aggregated sequential search query corresponding to the expanded child node.

4. The method of claim 3, wherein selecting one or more of the aggregated sequential search queries as suggested ad group themes further comprises:
receiving second user input selecting one or more of the plurality of child nodes in the hierarchy; and
using the aggregated sequential search queries corresponding to the selected child nodes as the suggested ad group themes.

5. The method of claim 1, wherein obtaining the first seed ad group theme further comprises:
determining respective performances of one or more existing ad groups in an advertising account based on one or more criteria;
selecting one of the existing ad groups as a seed ad group based on a better performance of the selected existing ad group among the existing ad groups; and
using a theme of the selected existing ad group as the first seed ad group theme.

6. The method of claim 1, wherein obtaining the first seed ad group theme further comprises:
monitoring respective performances of one or more existing ad groups in an advertising campaign;
selecting one of the existing ad groups as a seed ad group if the performance of the existing ad group exceeds a predetermined threshold; and
using a theme of the selected existing ad group as the first seed ad group theme.

7. The method of claim 1, wherein obtaining the first aggregated sequential search queries of the first seed search query further comprises:
periodically, obtaining an update on the first aggregated sequential search queries of the first seed search query, wherein the update indicate aggregated sequential search queries have been submitted to the search system within a most recent time period of a predetermined duration.

8. The method of claim 1, wherein creating one or more new ad groups for advertising in the content network further comprises:
for each of the one or more new ad groups:
obtaining a plurality of suggested keywords for the new ad group, the plurality of suggested keywords being based on the respective terms of the suggested ad group theme; and
creating the new ad group using a subset of the plurality of suggested keywords.

9. The method of claim 8, wherein creating the new ad group using the subset of the plurality of suggested keywords further comprises:
presenting the plurality of suggested keywords in an order according to a predetermined criterion;
receiving user input selecting the subset of suggested keywords from the plurality of suggested keywords; and
creating the new ad group using the user-selected subset of suggested keywords.

10. The method of claim 8, wherein creating the new ad group using the subset of the plurality of suggested keywords further comprises:
selecting the subset of suggested keywords based on a predetermined threshold search volume; and
creating the new ad group using the subset of suggested keywords selected based on the predetermined threshold search volume.

11. The method of claim 1, further comprising:
selecting at least one of the first aggregated sequential search queries of the first seed search query as a second seed search query;
obtaining second aggregated sequential search queries of the second seed search query;
selecting one or more of the second aggregated sequential search queries as additional suggested ad group themes; and creating additional new ad groups for advertising in the content network, each additional new ad group corresponding to a respective one of the additional suggested ad group themes.

12. A computer-implemented method performed by one or more data processing apparatus, comprising:
receiving a seed ad group theme from a user, the seed ad group theme consists of one or more terms;
presenting aggregated sequential search queries of a seed search query to the user, the seed search query consisting of the one or more terms of the seed ad group theme, and each of the aggregated sequential search queries being a respective search query that has been submitted in sequence with the seed search query to a search system by more than a threshold number of search engine users during a respective search session associated with each search engine user;
receiving first user input selecting one or more of the aggregated sequential search queries as new ad group themes;
presenting a respective plurality of suggested keywords for each new ad group theme;
receiving second user input selecting a subset of the respective plurality of suggested keywords as keywords for each new ad group theme; and
creating one or more new ad groups for advertising in a content network, each new ad group corresponding to a respective one of the new ad group themes and including the subset of suggested keywords selected for the new ad group theme.

13. A computer-implemented method performed by one or more data processing apparatus, comprising:
monitoring performance of one or more existing ad groups based on one or more predetermined performance measures;
selecting one of the existing ad groups as a seed ad group based on the ad group's performance, the selected seed ad group having an ad group theme consisting of one or more terms;
obtaining aggregated sequential search queries of a seed search query, the seed search query consisting of the one or more terms of the seed ad group theme, and each of the aggregated sequential search queries being a respective search query that has been submitted in sequence with the seed search query to a search system by more than a threshold number of search engine users during a respective search session associated with each search engine user;
selecting one or more of the aggregated sequential search queries as new ad group themes;
obtaining suggested keywords for each new ad group theme;
selecting one or more of the suggested keywords for each new ad group theme as keywords for inclusions in a respective new ad group corresponding to the new ad group theme; and
creating one or more new ad groups for advertising in a content network, each new ad group corresponding to a respective one of the new ad group themes and including the selected keywords for the new ad group theme.

14. A computer-readable medium having instructions stored thereon, which, when executed by at least one processor, cause the processor to perform operations comprising:
obtaining a first seed ad group theme, the first seed ad group theme consists of one or more terms;
obtaining first aggregated sequential search queries of a first seed search query, the first seed search query consisting of the one or more terms of the first seed ad group theme, and each of the first aggregated sequential search queries being a respective search query that has been submitted in sequence with the first seed search query to a search system by more than a threshold number of users during a respective search session associated with each user;
selecting one or more of the first aggregated sequential search queries as suggested ad group themes; and
creating one or more new ad groups for advertising in a content network, each new ad group corresponding to a respective one of the suggested ad group themes.

15. The computer-readable medium of claim 14, wherein obtaining the first seed ad group theme further comprises:
receiving, from a user and through an interface of a campaign management environment, the one or more terms of the first seed ad group theme.

16. The computer-readable medium of claim 15, wherein the operations further comprise:
presenting a hierarchy comprising a root node and a plurality of child nodes below the root node, the root node corresponding to the first seed search query, and each child node corresponding to a respective one of the first aggregated sequential search queries of the first seed search query;
receiving first user input expanding one of the plurality of child nodes, the expanded child node corresponding to a respective aggregated sequential search query; and
in response to the received first user input, presenting additional child nodes descending from the expanded child node, each additional child node corresponding to a respective second aggregated sequential search query of the respective aggregated sequential search query corresponding to the expanded child node.

17. The computer-readable medium of claim 16, wherein selecting one or more of the aggregated sequential search queries as suggested ad group themes further comprises:
receiving second user input selecting one or more of the plurality of child nodes in the hierarchy; and
using the aggregated sequential search queries corresponding to the selected child nodes as the suggested ad group themes.

18. The computer-readable medium of claim 14, wherein obtaining the first seed ad group theme further comprises:
determining respective performances of one or more existing ad groups in an advertising account based on one or more criteria;
selecting one of the existing ad groups as a seed ad group based on a better performance of the selected existing ad group among the existing ad groups; and
using a theme of the selected existing ad group as the first seed ad group theme.

19. The computer-readable medium of claim 14, wherein obtaining the first seed ad group theme further comprises:
monitoring respective performances of one or more existing ad groups in an advertising campaign;
selecting one of the existing ad groups as a seed ad group if the performance of the existing ad group exceeds a predetermined threshold; and
using a theme of the selected existing ad group as the first seed ad group theme.

20. The computer-readable medium of claim 14, wherein obtaining the first aggregated sequential search queries of the first seed search query further comprises:
periodically, obtaining an update on the first aggregated sequential search queries of the first seed search query, wherein the update indicate aggregated sequential search queries have been submitted to the search system within a most recent time period of a predetermined duration.

21. The computer-readable medium of claim 14, wherein creating one or more new ad groups for advertising in the content network further comprises:
for each of the one or more new ad groups:
obtaining a plurality of suggested keywords for the new ad group, the plurality of suggested keywords being based on the respective terms of the suggested ad group theme; and
creating the new ad group using a subset of the plurality of suggested keywords.

22. The computer-readable medium of claim 21, wherein creating the new ad group using the subset of the plurality of suggested keywords further comprises:
presenting the plurality of suggested keywords in an order according to a predetermined criterion;
receiving user input selecting the subset of suggested keywords from the plurality of suggested keywords; and
creating the new ad group using the user-selected subset of suggested keywords.

23. The computer-readable medium of claim 21, wherein creating the new ad group using the subset of the plurality of suggested keywords further comprises:
selecting the subset of suggested keywords based on a predetermined threshold search volume; and
creating the new ad group using the subset of suggested keywords selected based on the predetermined threshold search volume.

24. The computer-readable medium of claim 14, wherein the operations further comprise:
selecting at least one of the first aggregated sequential search queries of the first seed search query as a second seed search query;
obtaining second aggregated sequential search queries of the second seed search query;
selecting one or more of the second aggregated sequential search queries as additional suggested ad group themes; and
creating additional new ad groups for advertising in the content network, each additional new ad group corresponding to a respective one of the additional suggested ad group themes.

25. A system comprising:
one or more processors;
memory coupled to the one or more processors and operable for storing instructions, which, when executed by the one or more processors, cause the one or more processors to perform operations, comprising:
obtaining a first seed ad group theme, the first seed ad group theme consists of one or more terms;
obtaining first aggregated sequential search queries of a first seed search query, the first seed search query consisting of the one or more terms of the first seed ad group theme, and each of the first aggregated sequential search queries being a respective search query that has been submitted in sequence with the first seed search query to a search system by more than a threshold number of users during a respective search session associated with each user;
selecting one or more of the first aggregated sequential search queries as suggested ad group themes; and
creating one or more new ad groups for advertising in a content network, each new ad group corresponding to a respective one of the suggested ad group themes.

26. The system of claim 25, wherein obtaining the first seed ad group theme further comprises:
receiving, from a user and through an interface of a campaign management environment, the one or more terms of the first seed ad group theme.

27. The system of claim 26, wherein the operations further comprise:
presenting a hierarchy comprising a root node and a plurality of child nodes below the root node, the root node corresponding to the first seed search query, and each child node corresponding to a respective one of the first aggregated sequential search queries of the first seed search query;
receiving first user input expanding one of the plurality of child nodes, the expanded child node corresponding to a respective aggregated sequential search query; and
in response to the received first user input, presenting additional child nodes descending from the expanded child node, each additional child node corresponding to a respective second aggregated sequential search query of the respective aggregated sequential search query corresponding to the expanded child node.

28. The system of claim 27, wherein selecting one or more of the aggregated sequential search queries as suggested ad group themes further comprises:
receiving second user input selecting one or more of the plurality of child nodes in the hierarchy; and
using the aggregated sequential search queries corresponding to the selected child nodes as the suggested ad group themes.

29. The system of claim 25, wherein obtaining the first seed ad group theme further comprises:
determining respective performances of one or more existing ad groups in an advertising account based on one or more criteria;
selecting one of the existing ad groups as a seed ad group based on a better performance of the selected existing ad group among the existing ad groups; and
using a theme of the selected existing ad group as the first seed ad group theme.

30. The system of claim 25, wherein obtaining the first seed ad group theme further comprises:
monitoring respective performances of one or more existing ad groups in an advertising campaign;
selecting one of the existing ad groups as a seed ad group if the performance of the existing ad group exceeds a predetermined threshold; and
using a theme of the selected existing ad group as the first seed ad group theme.

31. The system of claim 25, wherein obtaining the first aggregated sequential search queries of the first seed search query further comprises:
periodically, obtaining an update on the first aggregated sequential search queries of the first seed search query, wherein the update indicate aggregated sequential search queries have been submitted to the search system within a most recent time period of a predetermined duration.

32. The system of claim 25, wherein creating one or more new ad groups for advertising in the content network further comprises:
for each of the one or more new ad groups:
obtaining a plurality of suggested keywords for the new ad group, the plurality of suggested keywords being based on the respective terms of the suggested ad group theme; and
creating the new ad group using a subset of the plurality of suggested keywords.

33. The system of claim 32, wherein creating the new ad group using the subset of the plurality of suggested keywords further comprises:
presenting the plurality of suggested keywords in an order according to a predetermined criterion;
receiving user input selecting the subset of suggested keywords from the plurality of suggested keywords; and
creating the new ad group using the user-selected subset of suggested keywords.

34. The system of claim 32, wherein creating the new ad group using the subset of the plurality of suggested keywords further comprises:
selecting the subset of suggested keywords based on a predetermined threshold search volume; and
creating the new ad group using the subset of suggested keywords selected based on the predetermined threshold search volume.

35. The system of claim 25, wherein the operations further comprise:
selecting at least one of the first aggregated sequential search queries of the first seed search query as a second seed search query;
obtaining second aggregated sequential search queries of the second seed search query;
selecting one or more of the second aggregated sequential search queries as additional suggested ad group themes; and
creating additional new ad groups for advertising in the content network, each additional new ad group corresponding to a respective one of the additional suggested ad group themes.
